(19) United States
(12) Patent Application Publication
(10) Pub. No.: US 2024/0123502 A1
(43) Pub. Date: Apr. 18, 2024

(54) TITANIUM ALLOY POWDER FOR SELECTIVE LASER MELTING 3D PRINTING, SELECTIVE LASER MELTED TITANIUM ALLOY AND PREPARATION THEREOF

(71) Applicant: Shanghai Jiao Tong University, Shanghai (CN)

(72) Inventors: Leyun Wang, Shanghai (CN); Xiaoqin Zeng, Shanghai (CN); Zhe Song, Shanghai (CN)

(73) Assignee: Shanghai Jiao Tong University, Shanghai (CN)

(21) Appl. No.: 18/351,892

(22) Filed: Jul. 13, 2023

Related U.S. Application Data
(63) Continuation of application No. PCT/CN2022/076406, filed on Feb. 16, 2022.

(30) Foreign Application Priority Data
Feb. 20, 2021 (CN) 202110192512.2

(51) Int. Cl. B22F 10/28; B22F 1/05; B22F 9/08; B33Y 10/00; B33Y 40/10; B33Y 70/00; C22C 1/03; C22C 14/00

(52) U.S. Cl. CPC B22F 10/28; B22F 1/05; B22F 9/082; B33Y 10/00; B33Y 40/10; B33Y 70/00; C22C 1/03; C22C 14/00; B22F 2009/0824; B22F 2301/205; B22F 2304/10; B22F 2998/10; B22F 2999/00

(57) ABSTRACT

The present disclosure relates to titanium alloy powder for selective laser melting (SLM) 3D printing, an SLM titanium alloy and the preparation thereof. The used titanium alloy powder comprises the following element components by weight percentage: 2.0 to 4.5% of Al, and 3.0 to 4.5% of V, with the balance being Ti and inevitable impurities. During preparation, a titanium sponge and an Al—V alloy are mixed and pressed into a block as a melting electrode; the titanium alloy ingot having good uniformity is obtained after smelting by using a vacuum consumable electric arc furnace for three times; and the ingot is forged twice and processed into a bar for powder-making. The bar for powder-making is subjected to processes such as washing and drying, atomizing, sieving, and airflow classification to prepare SLM titanium alloy powder. The titanium alloy powder is melted and stacked layer by layer by means of SLM equipment to finally obtain an SML titanium alloy block. Compared with the prior art, the SLM titanium alloy prepared in the present disclosure does not need to be subjected to subsequent heat treatment, and has excellent plasticity, tensile properties, isotropy, etc. during forming.

### CROSS REFERENCE TO RELATED APPLICATIONS

The present application is a National Phase Application of PCT Application No. PCT/CN2022/076406, filed on Feb. 16, 2022, which claims the priority of Chinese Patent Application No. 202110192512.2, filed on Feb. 20, 2021, the entire contents of which are hereby incorporated by reference.

### TECHNICAL FIELD

The present disclosure belongs to the technical field of titanium alloy material manufacturing, and relates to a titanium alloy powder for selective laser melting 3D printing, a selective laser melted titanium alloy and the preparation thereof.

### BACKGROUND

Titanium, comprising approximately 0.6% of the Earth's crust by mass, ranks among the most abundant metallic elements, following aluminum, iron, and magnesium. The density of titanium alloy is 4.5 g/mm³ (about half of superalloys and steel), and its strength is high. While meeting the strength requirements of material design, it greatly reduces the weight of the material and achieves good economic and environmental benefits. Therefore, it is widely used in aerospace, military and biomedical industries. Titanium alloys represented by Ti-6Al-4V have low density, high specific strength (about 3.5 times that of stainless steel), excellent corrosion resistance (about 15 times that of ordinary stainless steel), and a wide range of service temperatures (−196° C. to 600° C.), good biocompatibility and other advantages. The tensile strength of titanium alloy is usually 800 to 1200 MPa, and the elongation thereof is 8 to 16%. However, due to the low thermal conductivity of titanium alloys, it is easy to cause local temperature rise during the turning process, resulting in sticking of the tool and local work hardening of the material, making machining difficult and reducing the durability of the tool. In addition, the elastic modulus of titanium alloy is small, about half of that of iron. There is a certain amount of deformation resilience in the machining process, which is easy to cause machining accuracy errors. In the actual production process, the production efficiency and material utilization rate of titanium alloys are low, and the processing cycle is long, which seriously restrict the application of titanium alloys in the national defense industry and other fields.

In recent years, Selective Laser Melting (SLM) has emerged as a highly promising 3D printing technology with significant development prospects and application advantages. SLM has advantages of digital integration of near-net shape, high processing freedom, independence of parts complexity and a high material utilization rate. SLM provides a new solution for the rapid manufacture of complex titanium alloy components. SLM uses a laser heat source to melt the powder layers layer by layer according to a preset path, obtaining high-density near-net shaped parts. This technology achieves the requirements that cannot be achieved by traditional processes such as forging and casting. However, when compared with traditional forgings and castings, the as-built parts of Ti-6Al-4V alloy fabricated by SLM have poor plasticity, and the tensile elongation thereof is generally lower than 8%. In addition, the mechanical properties of the Ti-6Al-4V alloy fabricated by SLM have a large anisotropy: there are obvious differences in the tensile properties of the material parallel to the depositing direction (Z) and perpendicular to the depositing direction (X-Y). Poor plasticity and anisotropy make the Ti-6Al-4V alloy fabricated by SLM cannot be widely used currently in fields such as aerospace. Although subsequent heat treatment can improve the elongation of the material and reduce the anisotropy of the material, the heat treatment significantly increases the production cost and limits the application of these materials.

For example, Chinese Patent No. 202010797495.0 discloses a 3D printed fine-grained titanium alloy and a preparation method thereof. By adding boron and carbon elements in titanium alloy, the grains of this alloy can be refined to some extent, and the elongation of the alloy can be increased to about 11%. However, this material has three shortcomings: firstly, expensive boron element is required; secondly, the material needs to be heat treated at 600 to 700° C. after 3D printing; thirdly, the material strength is insufficient, with the yield strength by transverse sampling is only 801 MPa, and the tensile strength by transverse sampling is only 801 MPa, and the yield strength by longitudinal sampling is only 811 MPa, and the tensile strength by longitudinal sampling is only 868 MPa.

### SUMMARY

The purpose of the present disclosure is to provide a titanium alloy powder for selective laser melting 3D printing, a selective laser melted titanium alloy and a preparation thereof. The obtained alloy does not need subsequent heat treatment after SLM shaping, and can obtain ideal plasticity and isotropy at as built state, and meet the design strength requirements of titanium alloys for aviation.

The SLM titanium alloy obtained by the disclosure has a tensile strength of about 939 MPa, a yield strength of about 840 MPa, and a total elongation at fracture of about 13.98% in the direction perpendicular depositing direction. For mechanical properties of tensile direction parallel to metal deposition, it has a tensile strength of about 939 MPa, a yield strength of about 836 MPa, and the total elongation at fracture of about 13.07% at as built state.

The object of the present disclosure can be realized through the following technical solutions.

One of the technical solutions of the present disclosure provides a titanium alloy powder for SLM processing which includes the following element components by weight percentage: 2.0 to 4.5% of Al, 3.0 to 4.5% of V, with the balance being Ti and unavoidable impurities. Specifically, Al accounts for 2.0 to 4.5%, V accounts for 3.0 to 4.5%, Fe accounts for ≤0.25%, C accounts for ≤0.08%, N accounts for ≤0.05%, H accounts for ≤0.015%, O accounts for ≤0.13%, with the balance being Ti. Among them, the content of Al is 2.0, 2.5, 3.0, 3.5, 4.0 or 4.5, etc., and the content of V is 3.0, 3.5, 4.0 or 4.5, etc., but not limited to the listed values, and other unlisted values within the numerical range also apply.

In another embodiment, the titanium alloy powder for SLM processing includes the following element components by weight percentage: 7.0 to 8.0% of Al, 4.0 to 4.5% of V, with the balance being Ti and inevitable impurities. Specifically, Al accounts for 2.0 to 4.5%, V accounts for 4.0 to 4.5%, Fe accounts for ≤0.25%, C accounts for ≤0.08%, N accounts for ≤0.05%, H accounts for ≤0.015%, O accounts for ≤0.13%, with the balance being Ti.

The second technical solution of the present disclosure provides a method for preparing the selective laser melted titanium alloy, comprising the following steps:

(1) Preparation of Bar for Powder-Making:
sponge titanium and vanadium-aluminum master alloys are mixed according to the element stoichiometric ratio, pressed into a block, and then used as a smelting electrode for vacuum smelting to obtain a titanium alloy ingot, which is forged into a bar for powder-making;

(2) Preparation of Titanium Alloy Powder:
after being cleaned and dried, the bar for powder-making is melted and atomized to obtain the titanium alloy powders, which are the target product.

Further, in step (1), the preparation of the bar for powder-making specifically comprises:
(1-1) mixing titanium sponge and vanadium-aluminum master alloys according to an element stoichiometric ratio, then densifying and pressing the mixture into a block with a hydraulic press, and then welding the block onto the smelting electrode in an argon-protected plasma welding chamber;
(1-2) smelting the smelting electrode obtained in step (1-1) using a vacuum consumable electric arc furnace under vacuum protection to obtain the titanium alloy ingot;
(1-3) performing two passes of free forging on the titanium alloy ingot using a forging press, wherein, preferably, for the first pass, the titanium alloy ingot is forged into a bar stock with a larger diameter, and is forged into a bar blank with a smaller diameter after second pass, and the bar for powder-making is obtained after being processed by a lathe or the like.

Further, in step (1-1), the proportion of vanadium in the vanadium-aluminum master alloys are within a range of 40% to 70%.

Further, in step (1-2), the number of smelting times is at least three times. Preferably, in the three times of smelting, the smelting electrode is firstly melted as a consumable electrode to obtain a primary ingot, and the primary ingot is inverted and used as a consumable electrode for the second smelting in a vacuum consumable arc furnace to obtain a secondary ingot, and the secondary ingot is inverted and used as a consumable electrode for the third smelting in a vacuum consumable arc furnace to obtain the finished ingot.

Further, in step (1-3), the diameter of the obtained bar stock is 120 mm, and the diameter of the obtained bar blank is 53 mm.

Further, in step (2), the preparation of titanium alloy powder specifically comprises:
(2-1) after cleaning and drying the bar for powder-making, placing the bar for powder-making in a power atomization equipment (such as electrode induction gas power atomization equipment, or other techniques such as two fluids atomization, centrifugal atomization, rotating electrode atomization, etc.) under the protection of an inert gas;
(2-2) heating and melting the bar for powder-making under appropriate vacuum and protective gas conditions, wherein molten metal liquid falls into the atomizer nozzle and continuously flows out of the atomizer nozzle, and simultaneously introducing high-pressure gas into a tightly coupled nozzle (i.e., the atomizer nozzle) so that a high-speed airflow hits the molten metal liquid to atomize the molten metal liquid into a large number of fine droplets, wherein metal droplets are cooled and solidified in the atomization chamber, and then formed into spherical metal powder under the action of surface tension;
(2-3) sieving, classifying, and collecting the metal powder to obtain the titanium alloy powder with a particle size of 15 to 53 microns.

Further, in step (2-1), the cleaning and drying process specifically comprises: cleaning the bar for powder-making for 15 to 30 minutes using alcohol as a cleaning medium, and then drying the bar for powder-making at 120° C. for 2 hours;

In step (2-2), the atomization processing parameters are as follows: the working pressure of the high-pressure inert gas of the atomizing nozzle is 35 to 45 bar, the bar feeding rate is 40 to 60 mm/min, the heating and melting power of the bar for powder-making is 20 to 40 KW.

The third technical solution of the present disclosure is to provide a selective laser melted titanium alloy, which is made from the titanium alloy powder as described above by SLM 3D printing.

The fourth technical solution of the present disclosure is to provide a method for preparing the above-mentioned selective laser melted titanium alloy, wherein the method specifically comprises:
melting and depositing titanium alloy powder bed layer by layer by using a selective laser melting equipment to obtain selective laser melted bulk titanium alloy, which is the target product.

Further, in step (3), the preparation process of the titanium alloy block specifically comprises:
(3-1) placing the titanium alloy powders in the powder feeding cylinder of the selective laser melting equipment after drying and sieving the titanium alloy powder;
(3-2) preheating a substrate of the selective laser melting equipment; selectively scanning and melting the titanium alloy powder bed using the laser under the protection environment of an inert gas, and after each layer is scanned, lowering the substrate by one layer thickness and raising the powder feeding cylinder by one layer thickness; and forming a new layer of the titanium powder through the reciprocating motion of a scraper; wherein during the processing, the laser is controlled in a cross-scanning fashion by rotating 67° between each layer, this operation is repeated until all the preset slices are completed, and the titanium alloy block having the target size is obtained by layer-by-layer deposition, which is the target product.

Further, in step (3-2), the substrate is preheated to 75 to 110° C.

Further, during the processing, the parameters of the selective laser melting equipment are as following: the laser power is 250 to 350 W, and the diameter of laser beam is about 0.1 mm.

The laser is in a cross-scanning fashion to rotate 670 between each layer, the scanning speed is 100 to 1500 mm/s, the hatch spacing is 0.09 to 0.15 mm, the thickness of each titanium alloy powder layer is 30 to 60 microns, and the oxygen content is less than 1300 ppm.

The disclosure optimizes the alloy compositions for the selective laser melting process, wherein the contents of alloy elements of Al and V are changed based on the Ti6Al4V alloy system. The microscopic deformation mechanism of the titanium alloy can be regulated by the Al element, and the phase transition temperature of the titanium alloy can be regulated by the V element. Finally, a high elongation and isotropic titanium alloy is obtained. By optimizing the alloy compositions, the titanium alloy parts printed by SLM 3D directly meet the design requirements of titanium alloys for aviation, such as the standard “GJB2218A-2008—Specification of Titanium and Titanium Alloy Bars and Forging Stocks for Aircraft” (tensile strength is not less than 895 MPa, elongation is not less than 10%).

Compared with the prior art, the present disclosure has the following advantages:
(1) Compared with the selective laser melting of Ti6Al4V alloy, the elongation of the selective laser melting Ti—Al—V titanium alloy proposed by the present disclosure is significantly improved: the tensile strength perpendicular to the deposition direction is not less than 939 MPa, the yield strength is not less than 840 MPa, and the total fracture elongation is not less than 939 MPa. is 13.98%; the tensile strength parallel to the deposition direction is not less than 939 MPa, the yield strength is not less than 836 MPa, and the total elongation at fracture is 13.07%.
(2) The selective laser melted titanium alloy proposed by the present disclosure greatly improves the anisotropy of the material.

### BRIEF DESCRIPTION OF DRAWINGS

FIG. 1 is the scanning electron microscope photograph and particle size statistical distribution of the Ti—Al—V series titanium alloy powder prepared by the present disclosure.

FIG. 2 is the tensile result of the selective laser melted Ti—Al—V alloy obtained in the present disclosure and the comparative examples.

FIG. 3 is the grain orientation distribution map of the selective laser melted Ti—Al—V alloy obtained in the present disclosure and comparative example 1.

FIG. 4 is a histogram of the size distribution of the short-axis width of the grains of the Ti—Al—V alloy obtained by the selective laser melting of the present disclosure and comparative example 1.

FIG. 5 is the texture of the selective laser melted Ti—Al—V alloy obtained in the present disclosure and comparative example 1.

FIG. 6 shows the tensile properties of the selective laser melted Ti—Al—V alloy obtained in embodiment 4 of the present disclosure.

FIG. 7 shows the metallographic microstructure of the selective laser melted Ti—Al—V alloy obtained in embodiment 4 of the present disclosure.

FIG. 8 shows the EBSD scanning result of the selective laser melting of the Ti—Al—V alloy obtained in embodiment 4 of the present disclosure.

FIG. 9 shows the texture of the selective laser melted Ti—Al—V alloy obtained in embodiment 4 of the present disclosure.

FIG. 10 shows the transmission electron microscopy image of the selective laser melted Ti—Al—V alloy obtained in embodiment 4 of the present disclosure.

### DETAILED DESCRIPTION

The present disclosure will be described in detail below with reference to the accompanying drawings and specific embodiments. This embodiment is implemented based on the technical solution of the present disclosure, and provides a detailed implementation manner and a specific operation process, but the protection scope of the present disclosure is not limited to the following embodiments, and to those of ordinary skill in the art, several modifications and improvements can also be made without departing from the inventive concept. These all belong to the protection scope of the present disclosure.

In the following embodiments and comparative examples, if there is no special description of raw materials or processing techniques, it is indicated that they are all conventional commercially available raw materials or conventional processing techniques in the art.

### Embodiment 1

This embodiment relates to a high plasticity and isotropic selective laser melting of Ti-4Al-4V titanium alloy, wherein the element components are measured as: aluminum Al: 3.89 wt %, V: 3.61 wt %, with the balance being Ti alloy and inevitable impurities. The specific preparation process of the alloy is as follows:

(1) Processing of Bars for Powder-Making

Firstly, according to the ratio of the element mass percentage of Al and V, wherein Al is 4% and V is 4%, the sponge titanium and vanadium-aluminum master alloys (the content of V is 58%) are weighed. After the weighing, the vanadium-aluminum master alloys and sponge are mixed uniformly to make a mixture, and the mixture is pressed into a long strip by a hydraulic press. After that, the pressed strip is welded onto the smelting electrode to obtain a consumable electrode in a low-pressure argon-protected plasma welding chamber. Then the consumable electrode is installed and fixed on the vacuum smelting equipment. The vacuum smelting equipment is pumped to create a vacuum. After that, the consumable electrode is connected to the negative pole of the power supply, and the water-cooled copper mold is connected to the positive pole of the power supply. After the power is turned on, arc discharge occurs between the two poles. The high temperature generated by the arc melts the consumable electrode, and the electrode molten droplets fall into the water-cooled copper mold and are solidified to obtain an ingot. The primary ingot processed by the flat-end is inverted and welded to the smelting electrode again, and the vacuum smelting equipment is repeatedly operated to obtain a secondary ingot, and then the secondary ingot processed by the flat-end is inverted and welded on the smelting electrode for the third smelting, to obtain the finished ingot. After the finished ingot is cooled to below 200° C., the finished ingot is taken out of the smelting furnace. When the finished ingot is cooled to room temperature, both ends of the finished ingot are turned flat with a lathe, and the skin of the finished ingot is removed by turning to obtain a finished ingot for forging requirements. The finished ingot is forged twice with a forging press. The forging temperature range is 800° C. to 950° C. (about 850° C. in this embodiment). When the first hot forging is completed, a bar stock with a diameter of 120 mm can be obtained. After the second hot forging, a bar blank with a diameter of 53 mm is obtained, and the bar blank forged after the second forging is turned by a lathe to finally obtain a bar for powder-making with a diameter of 50 mm, and the processing of the bar for powder-making is completed.

(2) Obtaining Gas Atomized Powder

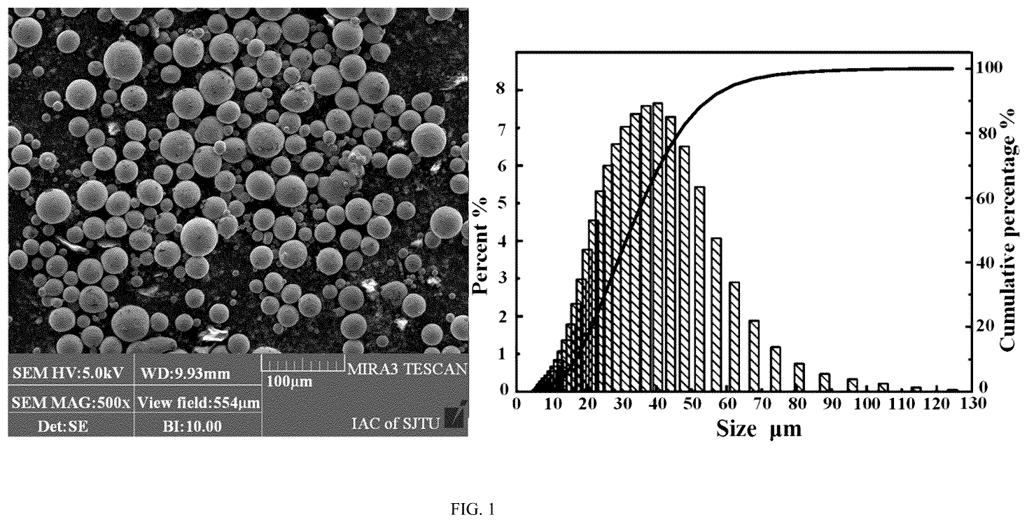

The bar for powder-making is machined using a lathe to create a conical shape near the gas atomizer nozzle. The conical end of the bar is conducive to the convergence of the molten droplets when the bar is melted. The turned bar for powder-making is ultrasonically cleaned, wherein the cleaning medium is alcohol, and the cleaning time is 15 min. After the cleaning is completed, the bar for powder-making is placed in an oven, and the oven temperature is set to 120° C. for 2 hours for drying. After the drying of the bar is completed, the bar for atomizing is sent to the high-frequency induction melting furnace of the electrode induction melting gas atomization equipment using the lifting and rotating mechanism of the electrode induction melting gas atomizing powder-making equipment. The melting furnace of the electrode induction melting gas atomization equipment is evacuated and filled with high-purity protective inert gas after the vacuuming is completed. Starting the heating power supply, and the bars for powdering are melted under the heating action of the annular induction coil in the melting furnace. The heating power of the bar for powder-making is 20-40 KW (in the present embodiment it is controlled at about 30 KW). At the same time, the bar for powder-making rotates slowly during the melting process, and a certain feeding rate is maintained to ensure that an uninterrupted molten metal liquid can be obtained. The feeding rate of the bar is 40 mm/min. The molten droplets fall into a specially designed atomizer close-coupled nozzle that connects the melting furnace to the atomizing chamber. At the same time, the nozzle of the electrode induction melting gas atomization equipment is fed with high-pressure inert gas, and the working pressure of the high-pressure inert gas of the nozzle is set to 35 to 45 bar. The gas flow of the high-speed airflow can be adjusted by adjusting the nozzle gap and the working pressure of the high-pressure inert gas. The high-speed airflow impacts and breaks the continuously flowing molten metal, causing it to atomize into fine metal droplets. The metal droplets fall into the atomizing chamber, and the flying droplets become spherical droplets under the action of surface tension. The spherical droplets are rapidly cooled and solidified into metal powder in the atomizing chamber. The titanium alloy metal powder is sieved, and then the metal powder is classified and collected by means of an airflow classification system, and finally the titanium alloy powder shown in FIG. 1 is obtained. As shown in FIG. 1, this gas atomization process yields highly spherical titanium alloy powder with a particle size distribution ranging from 5.5 to 124.5 μm and an average particle size of 34.61 μm.

(3) Selective Laser Melting Process

Before selective laser melting 3D printing, the titanium alloy powder is firstly dried, and the oven temperature is set to 100° C. for 2 hours. The dried powder is then sieved through a 53 μm aperture to obtain powder that meets the standard of “BD32/T3599-2019 Powder for Laser Selection of Titanium Alloy Parts”. The screened titanium alloy powder is placed in the powder feeding cylinder of the selective laser melting equipment. Next, the substrate used by the 3D printing equipment is installed and the substrate working platform is calibrated. After the substrate debugging is completed, the working chamber door of the selective laser melting device is closed.

Then, the selective laser melting equipment is turned on, and the substrate is preheated by using the selective laser melting equipment, wherein the preset temperature is set to 100° C. for 30 minutes. At the same time, high-purity argon is introduced into the selective laser equipment, and the high-purity argon is used to perform gas scrubbing on the selective laser melting equipment. and the gas scrubbing operation reduces the oxygen content in the selective laser melting equipment to below 1300 ppm to avoid oxidation of titanium alloys during the 3D printing process. During the process of introducing argon to reduce the oxygen content of the equipment, the import of 3D printing slice data can be carried out at the same time. After ensuring the oxygen content meets equipment requirements and importing the 3D printing file, powder pre-spreading is conducted to ensure good fusion between the first powder layer and the substrate. Once powder pre-spreading is completed, the 3D printing work can be carried out. During the 3D printing process, continuous argon gas supply maintains normal oxygen levels during printing. For the 3D printing process, the parameters of the selective laser melting equipment are set as follows: the laser power is 300 W, the scanning speed is 1200 mm/s, the thickness of the powder layer is 30 μm, the spot diameter is 0.07 mm, the hatch spacing is 0.12 mm, and the scanning method is cross-scanning method. The specific 3D printing process can be described as: after the laser heat source completes the scanning of the previous layer of metal powder, the substrate descends by one layer thickness (30 μm), while the powder feeding cylinder rises by one layer thickness (30 μm). And the reciprocating motion of the scraper is used to realize the spread of a new powder layer. After powder-spreading is completed, the angle of the scanning path of the laser is adjusted. The adjustment method is to rotate 670 relative to the scanning path of the previous layer, then the scanning of the next layer is started, and the powder spreading-scanning operation is repeated until all preset slices are completed. The metal block of 12*12*80 mm³ is finally obtained through the layer-by-layer deposition of metal powder. After the 3D printing is completed, the titanium alloy block and the substrate are separated by wire cutting.

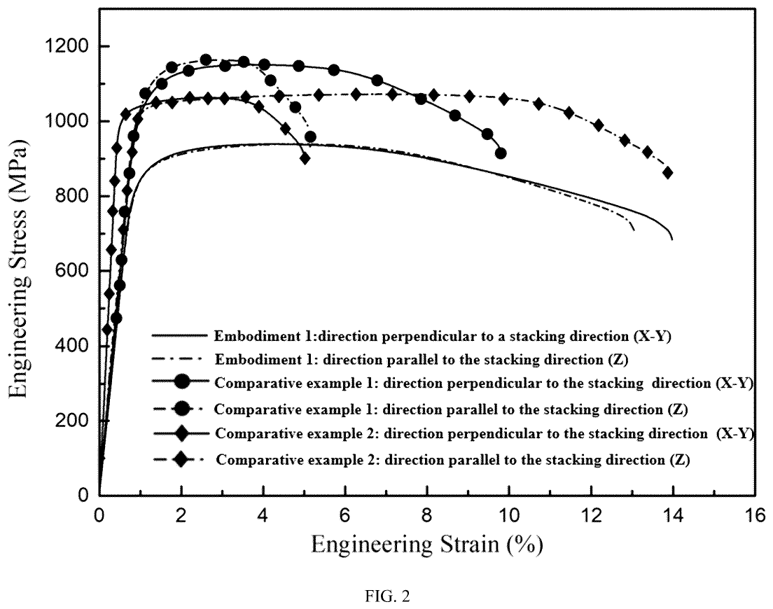

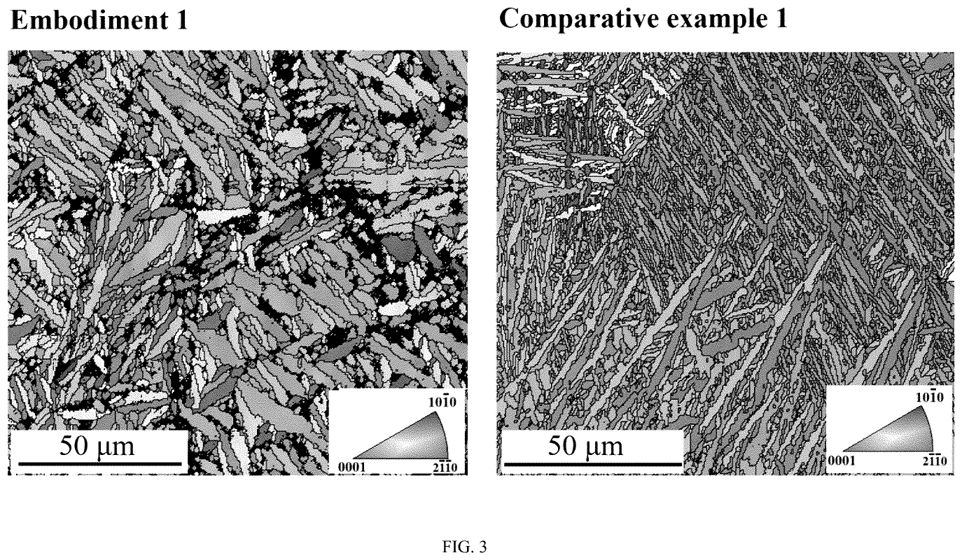

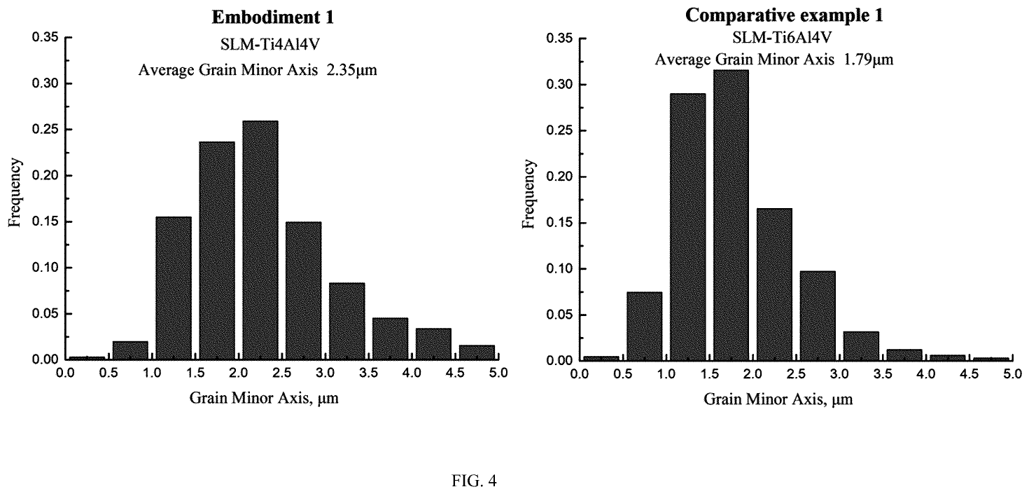

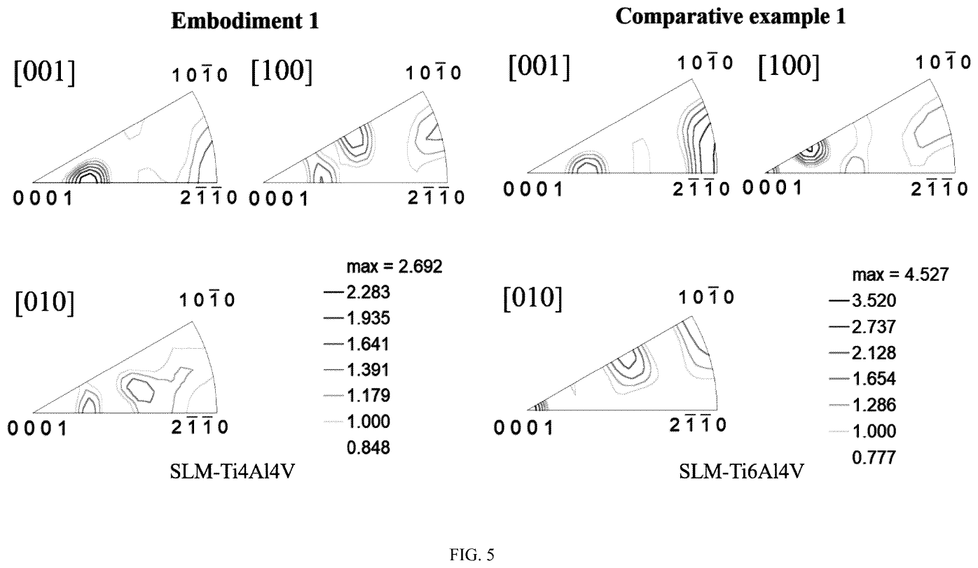

The titanium alloy block is subjected to wire cutting to obtain metal tensile specimens, and the tensile properties of the tensile specimens are tested. The test results are shown in FIG. 2. It can be seen from FIG. 2 that the selective laser melting of the Ti—Al—V titanium alloy obtained in this embodiment has good elongation when it is shaped, and the elongation parallel to the deposition direction and the elongation perpendicular to the deposition direction in embodiment 1 are basically the same, indicating that the product according to embodiment 1 has good isotropy. The tensile strength perpendicular to the deposition direction of the shaped material obtained in this embodiment is 939 MPa, the yield strength is 840 MPa, and the total elongation at fracture is 13.98%; the tensile strength parallel to the deposition direction is 939 MPa, the yield strength is 836 MPa, the total elongation at fracture is 13.07%, and the elongation of this alloy is significantly higher than that of the 3D printed Ti6Al4V alloy in comparative example 1. The high elongation of the alloy obtained in this embodiment is related to the microstructure change caused by the adjustment of alloying elements. Al alloying element is an important α-phase stabilizing element in titanium alloys. As shown in FIG. 3, the reduction of Al results in a short rod-like distribution of the grains, and the reduction of Al alloying element increases the width of the short axis of the grains compared to comparative example 1, as shown in FIG. 4, the average value of the short axis width of the grains in this embodiment is 2.35 μm, and the short axis of the grain is wider, which increases the effective movement length of dislocations during the deformation process of the material, so the material has a higher elongation rate when it is shaped. In addition, the reduction of Al alloying elements will cause the weakening of grain texture. As shown in FIG. 5, the maximum strength of the texture is only 2.69. The weaker texture of the material indicates that the grain orientation distribution is random, so it can activate more slip systems during the deformation process. The increase of slip systems makes the deformation process of the material more uniform, so the material in embodiment 1 has the characteristics of high elongation and isotropic mechanical properties.

### Comparative Example 1

In comparative example 1, the selective laser melting powder is Ti-6Al-4V alloy powder prepared by Falcon Rapid Manufacturing Technology Co., Ltd. in Wuxi City, Jiangsu Province. The alloy powder, identified as R56400, comprises the following elemental composition: Ti Bal, Al 5.50 to 6.75 wt %, V 3.50 to 4.50 wt %, Fe≤0.16 wt %, Y≤0.005 wt %. The powder exhibits a diameter ranging from 15 to 53 μm.

(1) Selective Laser Melting Process

Similar to the selective laser melting process in the embodiment, before the selective laser melting 3D printing, the titanium alloy powder is firstly dried, and the oven temperature is set to 100° C. for 2 hours. After that, the dried titanium alloy powder is poured into a sieve with an aperture of 53 μm and sieved. The screened titanium alloy powder is placed in the powder feeding cylinder of the selective laser melting equipment. Next, the substrate used by the 3D printing equipment is installed and the substrate working platform is calibrated. After the substrate installation is completed, the working chamber door of the selective laser melting equipment is closed. Then, the selective laser melting equipment is turned on, and the substrate is preheated by using the selective laser melting equipment, and the preheating temperature is set to 100° C. for 30 minutes. At the same time, high-purity argon gas is introduced into the selective laser equipment, and high-purity argon is used to perform gas scrubbing on the laser selection melting equipment. The gas scrubbing operation reduced the oxygen content in the equipment to below 1000 ppm to avoid the occurrence of oxidation of titanium alloys in the 3D printing process. During the process of introducing argon to reduce the oxygen content of the equipment, the import of 3D printing slice data can be carried out at the same time. When the oxygen content of the selective laser melting equipment meets the requirements and the 3D printing file is imported, pre-spread of powder can be performed, which can ensure good fusion between the first powder layer and the substrate. After preparation of the pre-spread of powder is completed, the 3D printing work can be carried out. During the 3D printing process, continuous supply of argon gas maintains the oxygen content at a normal working level. The parameters of the selective laser melting equipment in the 3D printing process are set as follows: the laser power is 500 W, the scanning speed is 1200 mm/s, the thickness of the powder layer is 30 μm, the spot diameter is 0.07 mm, the hatch spacing is 0.12 mm, and the scanning method is cross-scanning. The specific 3D printing process can be described as: after the laser heat source completes the scanning of the previous layer of metal powder, the substrate descends by one layer thickness (30 μm), while the powder feeding cylinder rises by one layer thickness (30 μm). And the reciprocating motion of the scraper is used to realize spread of a new layer of powder. After powder-spreading is completed, the angle of the scanning path of the laser is adjusted. The adjustment method is to rotate 670 relative to the scanning path of the previous layer, then the scanning of the next layer is started, and the powder-spreading-scanning operation is repeated until all preset slices are completed. The metal bulk sample of 12*12*80 mm³ is finally obtained by depositing metal powder layer by layer. After printing, the bulk titanium alloy material and the substrate are separated by wire cutting.

The bulk titanium alloy obtained in the comparative example is wire-cut to obtain a metal tensile specimen, and the tensile properties of the tensile specimen are tested. The test results are shown in FIG. 2. It can be seen from FIG. 2 that the elongation at fracture of the Ti-6Al-4V titanium alloy obtained in this comparative example by selective melting of the Ti-6Al-4V titanium alloy is significantly lower than that of the titanium alloy in embodiment 1, and the elongation parallel to the depositing direction is significantly lower than the elongation perpendicular to the depositing direction in comparative example 1, indicating that comparative example 1 has great anisotropy. The tensile strength perpendicular to the depositing direction of the alloy in this comparative example is 1151 MPa, the yield strength is 1043 MPa, and the total elongation at fracture is 9.8%; the tensile strength parallel to the depositing direction is 1163 MPa, the yield strength is 1064 MPa, but the total elongation at fracture is only 5.1%. The low elongation of 3D printed Ti-6Al-4V alloy is determined by its microstructure characteristics. As shown in FIG. 3, the grains in comparative example 1 are mostly slender and needle-shaped, and the grain width in comparative example 1 is smaller than that in embodiment 1. As shown in FIG. 4, the grains in comparative example 1 have an average value of the short-axis width is 1.79 μm, which is lower than the average value of the short-axis width of the grains (2.35 μm) in the embodiment. The smaller grain width limits the distance of dislocation movement during tensile deformation, which in turn reduces the elongation at fracture of the material. At the same time, the smaller grain width means that there are more grain boundaries in comparative example 1. The grain boundaries hinder the movement of dislocations and cause dislocations to accumulate at the grain boundaries. The accumulated dislocations cause high stress concentration and accelerate failure of the specimen during stretching, resulting in a decrease in elongation. In addition, the 3D printed titanium alloy in comparative example 1 has a strong texture. As shown in FIG. 5, the maximum texture strength is 4.53, which is higher than that in embodiment 1. Therefore, compared with the grains in embodiment 1, the grains of the comparative example 1 have an obvious preferred orientation. When stretched in the direction of the grain orientation that is favorable for slip activation, the material has a high elongation, while when stretched in the direction that is not favorable for slip activation, the material has low plasticity. Therefore, the strong texture characteristics of the microstructure in comparative example 1 make it have significant anisotropy in comparative example 1.

### Comparative Example 2

The Ti-6Al-4V alloy powder and most of the processes used in comparative example 2 are the same as in comparative example 1, except that in this comparative example, after the titanium alloy 3D printing is completed, it is placed in a box-type heat treatment furnace for heat treatment with the temperature 730° C. When the temperature of the heat treatment furnace rises to 730° C., the tensile specimens processed by wire cutting are placed in the heat treatment furnace, and kept at 730° C. for 2 hours. After that, the power of the heat treatment furnace is turned off, and the titanium alloy tensile specimens are cooled with the furnace. After reaching room temperature, they are removed from the furnace, and sandpaper is used to smoothen the heat-treated specimens before conducting the tensile property test.

The elongation parallel to the depositing direction of the heat-treated 3D printed titanium alloy obtained in this comparative example is comparable to the elongation parallel to the depositing direction in embodiment 1, but the elongation perpendicular to the depositing direction in this comparative example is significantly lower than the elongation perpendicular to the depositing direction in embodiment 1. In addition, the elongation perpendicular to the depositing direction in this comparative example is significantly lower than the elongation parallel to the depositing direction, indicating that the comparative example 2 still has great anisotropy. The tensile results are shown in FIG. 2. The tensile strength perpendicular to the depositing direction is 1063 MPa, the yield strength is 999 MPa, and the total elongation at fracture is only 5%; the tensile strength parallel to the depositing direction is 1072 MPa, the yield strength is 1025 MPa, and the total elongation at fracture is 13.9%. The tensile results clearly demonstrate that even after high-temperature heat treatment, the alloy in comparative example 2 does not possess the isotropic characteristics observed in embodiment 1. The elongation along the direction perpendicular to the depositing direction in comparative example 2 is significantly lower than that in embodiment 1. Therefore, the comparison results show that the 3D printed titanium alloy in embodiment 1 is highly innovative.

### Embodiment 2

Compared with embodiment 1, most of the parts are the same, except that in this embodiment, the weight percent of each element component in the titanium alloy is adjusted to: Al 2.0%, V 4.5%, with the balance being Ti and inevitable impurities element.

### Embodiment 3

Compared with embodiment 1, most of the parts are the same, except for the adjustment of the weight percentage composition of each element component in the titanium alloy of this embodiment. The weight percents are adjusted as follows: Al 4.5%, V 3.0%, with the balance being Ti and inevitable impurities element.

### Embodiment 4

This embodiment provides a high-intensity selective laser melting of Ti-8Al-4V titanium alloy, and its element components are measured as: Al: 7.93 wt %, V: 4.03 wt %, Fe: 0.044 wt %, C: 0.0093 wt %, N: 0.015 wt %, H: 0.0031 wt %, O: 0.090 wt %, with the balance being Ti alloy and inevitable impurities, and the specific preparation process is the same as that of the titanium alloy in embodiment 1.

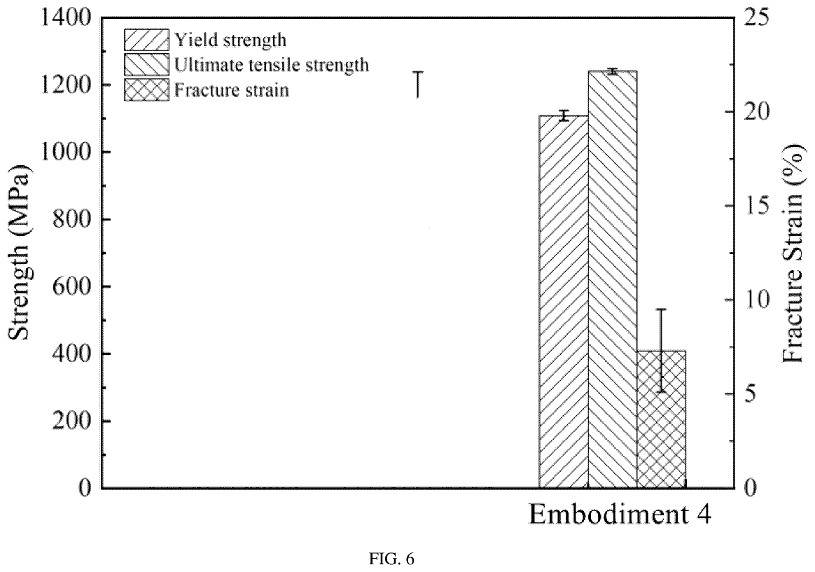

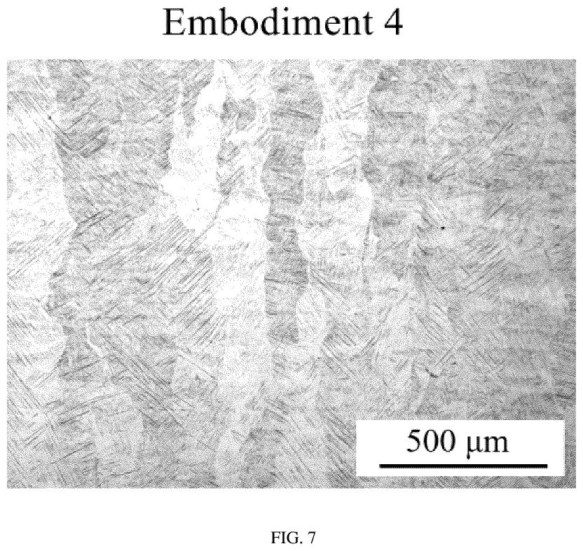

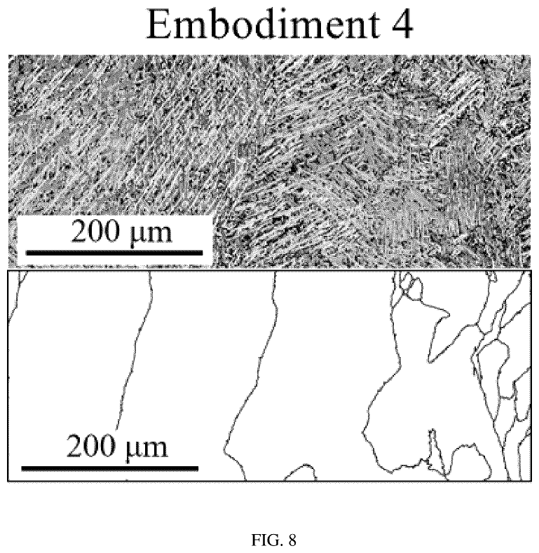

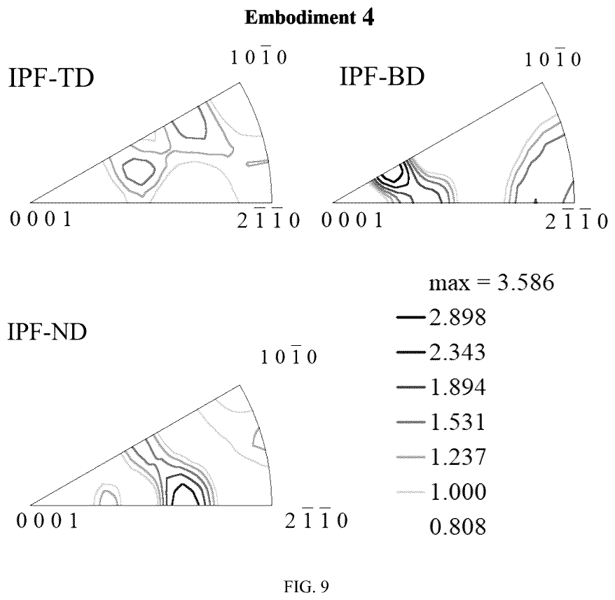

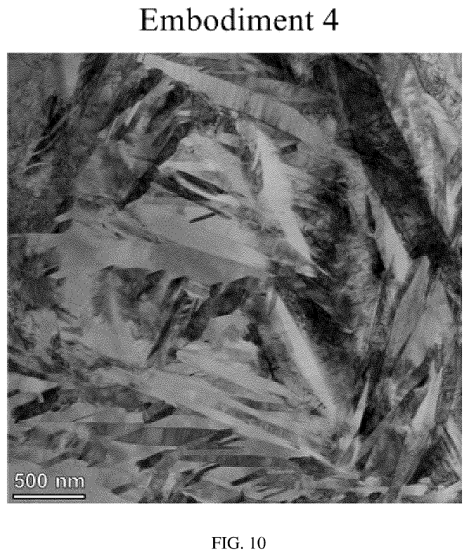

The Ti-8Al-4V titanium alloy obtained in embodiment 4 is characterized, and the characterization results are shown in FIGS. 6 to 10. FIG. 6 shows the tensile properties of the selective laser melted Ti—Al—V alloy obtained in embodiment 4 of the present disclosure. FIG. 7 shows the metallographic microstructure of the selective laser melted Ti—Al—V alloy obtained in embodiment 4 of the present disclosure. FIG. 8 shows the EBSD scanning result of the selective laser melting of the Ti—Al—V alloy obtained in embodiment 4 of the present disclosure. In FIG. 8, the upper part is the calibration of the primary α′ phase, and the lower part is the morphology of the prior β phase grains reconstructed according to the phase transition crystallographic relationship of β→α′ phase. FIG. 9 shows the texture of the selective laser melted Ti—Al—V alloy obtained in embodiment 4 of the present disclosure. FIG. 10 shows the transmission electron micrograph of the selective laser melted Ti—Al—V alloy obtained in embodiment 4 of the present disclosure.

It can be seen from FIG. 6 that the yield strength of the Ti-8Al-4V titanium alloy obtained in embodiment 4 is 1109 MPa, the maximum tensile strength is 1240 MPa, and the fracture strain is 7.3%. As can be seen from FIG. 7, the Ti-8Al-4V titanium alloy obtained in embodiment 4 is a coarse columnar grain. As can be seen from FIG. 8, the lath width of the Ti-8Al-4V titanium alloy obtained in embodiment 4 is 2.29±1.07 μm. It can be seen from FIG. 9 that the Ti-8Al-4V titanium alloy obtained in embodiment 4 has a strong texture. As can be seen from FIG. 10, the lath width of the secondary α′ phase of the Ti-8Al-4V titanium alloy obtained in embodiment 4 is 0.2 μm.

It can be seen from the above data that, compared with comparative example 1, when the Al content increases to 8%, the primary grains are coarse columnar crystals, the texture is gradually enhanced, resulting in an increased anisotropy of the material. When the Al content increases to 8%, the dislocation slip mode is still plane slip, so the plasticity of the obtained titanium alloy is not much different from that of the titanium alloy when the Al content is 6%. As the Al content increases from 6% to 8%, the strength of the titanium alloy material increases and the plasticity decreases slightly.

The reason for the increase in strength may be attributed to the tapering of both the primary and secondary martensitic laths.

The foregoing description of the embodiments is provided to facilitate understanding and use of the disclosure by those of ordinary skill in the art. It will be apparent to those skilled in the art that various modifications to these embodiments can be readily made, and the generic principles described herein can be applied to other embodiments without inventive step. Therefore, the present disclosure is not limited to the above-mentioned embodiments, and improvements and modifications made by those skilled in the art according to the disclosure of the present disclosure without departing from the scope of the present disclosure should all fall within the protection scope of the present disclosure.

What is claimed is:

1. A titanium alloy powder for selective laser melting 3D printing, comprising the following element components by weight percentage: 2.0 to 4.5% of Al, 3.0 to 4.5% of V, with the balance being Ti and inevitable impurities; or,
comprising the following element components by weight percentage: 7.0 to 8.0% of Al, 4.0 to 4.5% of V, with the balance being Ti and inevitable impurities.

2. A method for preparing the titanium alloy powder for selective laser melting 3D printing according to claim 1, comprising the following steps:
(1) preparation of a bar for powder-making:
sponge titanium and vanadium-aluminum master alloys are mixed according to the element stoichiometric ratio, pressed into a block, and then used as a smelting electrode for vacuum smelting to obtain a titanium alloy ingot, and then the titanium alloy ingot is forged into the bar for powder-making;
(2) preparation of the titanium alloy powder:
after being cleaned and dried, the bar for powder-making is melted and atomized to obtain the titanium alloy powder, which is the target product.

3. The method for preparing the titanium alloy powder for selective laser melting 3D printing according to claim 2, wherein in step (1), the preparation of a bar for powder-making specifically comprises:
(1-1) mixing titanium sponge and vanadium-aluminum master alloys according to the element stoichiometric ratio, then densifying and pressing the mixture into a block with a hydraulic press, then, in an argon-protected plasma welding chamber, welding the block onto the smelting electrode;
(1-2) smelting the smelting electrode obtained in step (1-1) using a vacuum consumable electric arc furnace under vacuum protection to obtain the titanium alloy ingot;
(1-3) performing two passes of free forging on the titanium alloy ingot using a forging press to obtain the bar for powder-making.

4. The method for preparing the titanium alloy powder for selective laser melting 3D printing according to claim 3, wherein in step (1-1), the proportion of vanadium in the vanadium-aluminum master alloys is within a range of 40% to 70%;
in step (1-2), the number of smelting times is at least three times;
in step (1-3), the diameter of the obtained bar stock is 120 mm, and the diameter of the obtained bar blank is 53 mm.

5. The method for preparing the titanium alloy powder for selective laser melting 3D printing according to claim 2, wherein in step (2), the preparation of the titanium alloy powder specifically comprises:
(2-1) placing the bar for powder-making in a power atomization equipment under the protection of an inert gas after cleaning and drying the bar for powder-making;
(2-2) heating and melting the bar for powder-making, wherein molten metal liquid falls into the atomizer nozzle and continuously flows out of the atomizer nozzle; and
introducing high-pressure inert gas into the atomizer nozzle so that the molten metal liquid is atomized and crushed into many fine droplets, wherein the droplets are cooled and solidified in the atomization chamber, and then formed into metal powders under the action of surface tension;
(2-3) sieving, classifying, and collecting the metal powder to obtain the titanium alloy powder with a particle size of 15 to 53 μm.

6. The method for preparing the titanium alloy powder used for selective laser melting 3D printing according to claim 5, wherein, in step (2-1), the cleaning and drying process specifically comprises: cleaning the bar for powder-making for 15 to 30 minutes using alcohol as a cleaning medium, and then drying the bar for powder-making at 120° C. for 2 hours;
wherein in step (2-2), the atomization processing in the powdering process are as follows: the working pressure of the high-pressure inert gas of the atomizing nozzle is 35 to 45 bar, the feeding rate of the bar for powder-making is 40 to 60 mm/min, and the heating and melting power of the bar for powder-making is 20 to 40 KW.

7. A selective laser melted titanium alloy, wherein the selective laser melted titanium alloy is made from the titanium alloy powder according to claim 1 by selective laser melting 3D printing.

8. A method for preparing the selective laser melted titanium alloy according to claim 7, comprising melting and depositing the titanium alloy powder bed layer by layer using a selective laser melting equipment to obtain a selective laser melted bulk titanium alloy, which is the target product.

9. The method for preparing the selective laser melted titanium alloy according to claim 7, wherein the preparation process of the selective laser melted bulk titanium alloy specifically comprises:
(3-1) placing the titanium alloy powder in the powder feeding cylinder of the selective laser melting equipment after drying and sieving the titanium alloy powder;
(3-2) preheating the substrate of the selective laser melting equipment; selectively scanning and melting the titanium alloy powder bed using the laser under the protection environment of an inert gas, and after the scanning of each layer is completed, lowering the substrate by one layer thickness and raising the powder feeding cylinder by one layer thickness; and forming a new layer of the titanium powder by the reciprocating motion of a scraper; wherein during the processing, the laser is controlled in a cross-scanning strategy to rotate 670 between each layer and this operation is repeated until all the preset slices are completed, and the titanium alloy block having the target size is obtained by layer-by-layer deposition, which is the target product.

10. The method for preparing the selective laser melted titanium alloy according to claim 9, wherein in step (3-2), the substrate is preheated to a temperature of 75 to 110° C.;
during the processing, the parameters of the selective laser melting equipment are as follows: the laser power is 250 to 350 W, and the laser beam diameter is about 0.1 mm;
the laser is in a cross-scanning fashion to rotate 670 after each layer is scanned, the scanning speed is 100 to 1500 mm/s, the hatch spacing is 0.09 to 0.15 mm, the thickness of each titanium alloy powder layer is 30 to 60 μm, and the oxygen content is less than 1300 ppm.
